(19) United States
(12) Patent Application Publication
(10) Pub. No.: US 2026/0228947 A1
(43) Pub. Date: Aug. 6, 2026

(54) IMAGE GENERATION METHOD AND APPARATUS, DEVICE, AND STORAGE MEDIUM

(71) Applicant: Beijing Zitiao Network Technology Co., Ltd., Beijing (CN)

(72) Inventors: Maoke YANG, Beijing (CN); Lanbo LIN, Beijing (CN); Hao XUE, Beijing (CN); Jiyuan TIAN, Beijing (CN)

(21) Appl. No.: 19/153,284

(22) PCT Filed: Jan. 29, 2024
(86) PCT No.: PCT/CN2024/074366

§ 371 Date: Aug. 1, 2025

(30) Foreign Application Priority Data
Feb. 2, 2023 (CN) 202310120184.4

(51) Int. Cl. G06T 11/60; G06T 11/10

(52) U.S. Cl. CPC G06T 11/60; G06T 11/10

(57) ABSTRACT

Embodiments of the present disclosure provide an image generation method and apparatus, a device, and a storage medium. The method comprises: performing material analysis processing on an original material of a target object to obtain a target image-text material of the target object; on the basis of the target image-text material and image generation configuration information of the target object, generating target image information; and generating and displaying a target poster type image of the target object on the basis of the target image information.

### CROSS REFERENCE TO RELATED APPLICATIONS

The present application is a national phase application of international application no. PCT/CN2024/074366 filed on Jan. 29, 2024, which is based on and claims priority to Chinese Application No. 202310120184.4 filed on Feb. 2, 2023, the disclosures of which are incorporated by reference herein into the present application in their entireties.

### TECHNICAL FIELD

Embodiments of the present disclosure relate to the technical field of image processing, and in particular an image generation method and apparatus, a device, and a storage medium.

### BACKGROUND

At present, ways for business expansion are diversified, and posters, as an artistic and functional medium, are widely applied to business publicity and information spreading. For example, businesses firms can promote their own commodities through posters.

### SUMMARY

The present disclosure provides an image generation method and apparatus, a device, and a storage medium to realize automatic generation of poster type images, which effectively improves the generation efficiency.

According to a first aspect, an embodiment of the present disclosure provides an image generation method, which comprises:
performing material parse processing on an original material of a target object to obtain a target image-text material of the target object;
generating target image information based on the target image-text material and image generation configuration information of the target object;
generating and presenting a target poster type image of the target object based on the target image information.

According to a second aspect, an embodiment of the present disclosure further provides an image generation apparatus, which comprises:
a material processing module for performing material parse processing on an original material of a target object to obtain a target image-text material of the target object;
an information generation module for generating target image information based on the target image-text material and image generation configuration information of the target object;
a poster generation module for generating and presenting a target poster type image of the target object based on the target image information.

According to a third aspect, an embodiment of the present disclosure further provides an electronic device, which comprises:
one or more processors;
a storage means for storing one or more programs;
wherein the one or more programs, when executed by the one or more processors, cause the one or more processors to implement the image generation method according to any embodiment of the present disclosure.

According to a fourth aspect, an embodiment of the present disclosure further provides a storage medium containing computer executable instructions which, when executed by a computer processor, are used for executing the image generation method according to any embodiment of the present disclosure.

The technical solution of the embodiments of the present disclosure provides an image generation method, comprising: firstly, performing material parse processing on an original material of a target object to obtain a target image-text material of the target object; then generating target image information based on the target image-text material and image generation configuration information of the target object; finally generating and presenting a target poster type image of the target object by rendering the target image information.

### BRIEF DESCRIPTION OF THE DRAWINGS

The above-mentioned and other features, advantages and aspects of various embodiments of the present disclosure will become more apparent with reference to the following specific implementations when taken in conjunction with the accompanying drawings. Throughout the drawings, the identical or similar reference numerals indicate the identical or similar elements. It should be understood that the drawings are schematic, and the parts and elements are not necessarily drawn to scale.

FIG. 1 shows a schematic flow diagram of an image generation method provided by an embodiment of the present disclosure;

FIG. 2 shows a schematic flow diagram of another image generation method provided by an embodiment of the present disclosure;

FIG. 3 shows a schematic structural diagram of an image generating apparatus provided by an embodiment of the present disclosure;

FIG. 4 shows a schematic structural diagram of an electronic device provided by an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method implementations of the present disclosure can be performed in a different order and/or in parallel. Furthermore, the method implementations can include additional steps and/or omit performing the illustrated steps. The scope of the present disclosure is not limited in this respect.

The term “including” and its variants used herein are open-ended including, that is, “including but not limited to”. The term “based on” is “at least partially based on”; the term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different means, modules or units, and are not used to limit the order or interdependence of the functions performed by these means, modules or units.

It should be noted that the modifications of “a” and “a plurality” mentioned in the present disclosure are schematic rather than limiting, and those skilled in the art should understand that unless the context clearly indicates otherwise, they should be understood as “one or a plurality”.

Names of messages or information exchanged among a plurality of means in the implementations of the present disclosure are only used for illustrative purposes, and are not used to limit the scope of these messages or information.

It can be understood that before the technical solutions disclosed in various embodiments of the present disclosure are used, users should be informed of the types, scope of use, use scenarios, etc. of personal information involved in the present disclosure in an appropriate way according to relevant laws and regulations, and authorization of users should be obtained.

For example, in response to receiving a user's active request, prompt information is sent to the user to clearly inform the user that the operation requested by the user will require acquiring and using the user's personal information. Therefore, the user can independently select whether to provide personal information to software or hardware such as an electronic device, an application, a server or a storage medium that performs the operations of the technical solutions of the present disclosure according to the prompt information.

As an optional but non-limiting implementation, the means of sending, in response to receiving a user's active request, prompt information to the user can be, for example, a pop-up window, in which the prompt information can be presented in text. In addition, the pop-up window can also carry a selection control for the user to select “agree” or “disagree” to provide personal information to the electronic device.

It can be understood that the above-mentioned process of notifying and acquiring user authorization is only schematic, and does not limit the implementation of the present disclosure. Other ways to meet relevant laws and regulations can also be applied to the implementation of the present disclosure.

It can be understood that the data involved in the present technical solution (including but not limited to the data itself, data acquisition or use) shall comply with the requirements of corresponding laws, regulations and relevant regulations.

It should be noted that one application scenario of the present embodiment can be described as: when a business firm wants to promote and spread a certain business object or product by way of poster type images, the poster type images need to be generated. In the related technologies, the business firm needs to invest manpower to design the posters manually. On the one hand, this manner needs to invest labor costs, on the other hand, the designed images have certain limitations as influenced by the experience of designers.

Based on this, the present embodiment provides an image generation method that can automatically generate poster type images. FIG. 1 shows a schematic flow diagram of an image generation method provided by an embodiment of the present disclosure. The embodiment of the present disclosure is applicable to the situation of rendering a three-dimensional space scene. The method can be executed by an image generation apparatus, which can be implemented in the form of software and/or hardware, or alternatively, by an electronic device. The electronic device can be a mobile terminal, a PC terminal, a server, or the like.

As shown in FIG. 1, the method of the embodiment of the present disclosure can specifically include:

S101: performing material parse processing on an original material of a target object to obtain a target image-text material of the target object.

In the present embodiment, the target object can be understood as a commodity or product of a to-be-generated image in actual business, which can be a real or cartoon character or animal, or a real daily product. The original material can be understood as unprocessed text information or picture information containing the related content of the target object. As the original material, the text information can be information describing the characteristics, functions, product names or other attributes of the target object. As the original material, the image information can contain images formed by shooting the target object in various shooting angles, or images presenting the target object in different styles.

It can be understood that, in order to generate poster type images related to the target object, it is necessary to ensure that the poster type images can contain descriptions of key information such as the form and function of the target object. This information can be contained in the original material of the target object. It is necessary to perform parse processing on the original material through this step to obtain the key content for publicity of the target object. The key content can be an image presenting the form of the target object or text presenting the function or efficacy of the target object.

In the present embodiment, there may be a plurality of images containing the target object in the original material, and the presentation forms of the target object contained in different images are different. Meanwhile, a text content also needs to be recognized for the text information contained in the original material. In this step, performing material parse processing on the original material can be described as: selection of available images, recognition of key contents, cutout of images of the target object, extraction of the text of the product selling points, and the like are performed for the images in the original material. In this step, the images and text information obtained after the material parse processing can be used as the key materials required for the poster type image generation, and these key materials are recorded as the target image-text materials in the present embodiment.

It should be noted that a plurality of image materials related to the target object may be obtained in the material parse processing. In the present embodiment, it is possible to perform preliminary screening on the obtained plurality of image materials to obtain a to-be-parsed image material, and then perform parse processing on the to-be-parsed image material by means of image feature extraction, image recognition, cutout and other algorithms to obtain the processed cut-out images and other candidate results, then screen the candidate results again by means of scoring, sorting and the like, and finally obtain an optimal image material from the candidate results as the target image element contained in the target image-text material.

S102: generating target image information based on the target image-text material and image generation configuration information of the target object.

It should be noted that the method provided by the present embodiment is mainly to realize the automatic generation of poster type images. For automatically generating the poster type images, it is necessary to know the composition of key elements in the poster type images first. It can be known that the poster type images are mainly used for promoting or spreading the target object, and thus the related images and/or text of the target object will be regarded as a key element in the poster type images. In addition, in order to reflect the novelty and attraction of poster type images, it is also necessary to include some creative elements, such as decorations, background images and other decorative elements. Meanwhile, it is also necessary to know how to lay out and color the element information in poster generation, which correspond to descriptive information required by poster generation.

Based on the above-mentioned description, in the present embodiment, the information related to poster generation of the target object can be generated based on the above-determined target image-text material and the pre-acquired image generation configuration information through this step, and is recorded as the target image information in the present embodiment. The image generation configuration information can be understood as some limiting information pre-given by the relevant personnel of the demand side for the to-be-generated poster, such as the size and resolution of the poster type image, the limiting or constraint information for the contained element content.

For the acquisition of the image generation configuration information, one of the implementations can be described as: the executive body of the method provided by the present embodiment provides an information editing interface to the demand side of poster generation, and the demand side can configure the information for the to-be-generated poster through the information editing interface. Another implementation for acquisition is to find configuration information for poster generation that has strong correlation with the target object in a pre-built poster information base.

In the present embodiment, the target image information can be understood as an executable file that can be directly used for rendering poster type images. The target image information can include descriptions of which image materials, text materials, background elements and decorative elements are used, layout information descriptions of how to lay out image materials and text materials in poster type images, and color matching information descriptions of how to match colors for image materials, text materials and even background elements and decorative elements in poster type images.

As an example, the process of generating the target image information from the target image-text material and the image generation configuration information in this step can be described as: it is possible to firstly obtain element components matching the target object from the pre-existing image element components by screening based on the target image-text material of the target object in combination with feedback information of the existing poster type images after spreading, and form target component information for the obtained element components; then, combine the target component information with the image generation configuration information to determine the layout descriptive information, color matching descriptive information, and the like of the poster type images as the target image information of the poster type images corresponding to the target object.

The target component information formed above can be considered as a creative strategy description for poster type image generation on the basis of the obtained element components, such as what kind of decorative elements are used, what kind of background image elements are used, how the images and texts in the target image-text material should be distributed, what are the presentation sizes and presentation positions of the element components, and etc.

On the basis of the target component information in combination with the constraint description of poster type image generation included in the image generation configuration information, more accurate descriptive information related to poster layout and descriptive information related to poster color matching can be determined. For example, the target component information can describe the relative positions that the image material and the text material should have, and in combination with a constraint description that there can be no content overlap of images and texts in the image generation configuration information, the specific positions and specific presentation sizes of the image material and the text material in the poster type image can be determined. For another example, the target component information gives color information of the image-text material, the background element and the like, and in combination with the constraints on the presentation of color harmony in the image generation configuration information, the color matching information that each element component should have in the poster can be determined.

S103: generating and presenting a target poster type image of the target object based on the target image information.

In the present embodiment, after determining the executable target image information through the above-mentioned step, it is possible to realize, through this step, the rendering of the image content contained in the target image based on the target element components contained in the target image information, the component information related to the element components, the image layout information and image color matching information of the whole image, and finally generate the target image of the target object. The target image can be a poster type image of the target object. The generated target image can be presented on the screen interface of the executive body or forwarded to the terminal used by the demand side for viewing by the demand side.

Illustratively, in this step, it is possible to allow each target element component that should be presented in the target image to realize layout rendering and color matching rendering in a certain order according to the information description of image layout and image color matching in the target image information, so as to ensure that effect superposition and integration can be performed for the target element components with the specified size and specified color at the specified position, and realize the output of the whole image content of the target image.

The image generation method provided by the present embodiment can realize the automatic generation of poster type images. Compared with the existing manually designed posters based on professional designers, this technical solution greatly reduces the cost of poster generation and improves the efficiency of poster generation. In the execution of the whole technical solution, the selection of the image-text material required for poster production of the target object is realized by material parse processing, and meanwhile the determination of key information required for poster production is realized by generating matching target image information corresponding to the target object. The poster type images generated in the above-mentioned manner can achieve the effect of better fitting the target object, reduce the limitations of the content presented by the poster type images while improving the generation efficiency, and improve the generation quality.

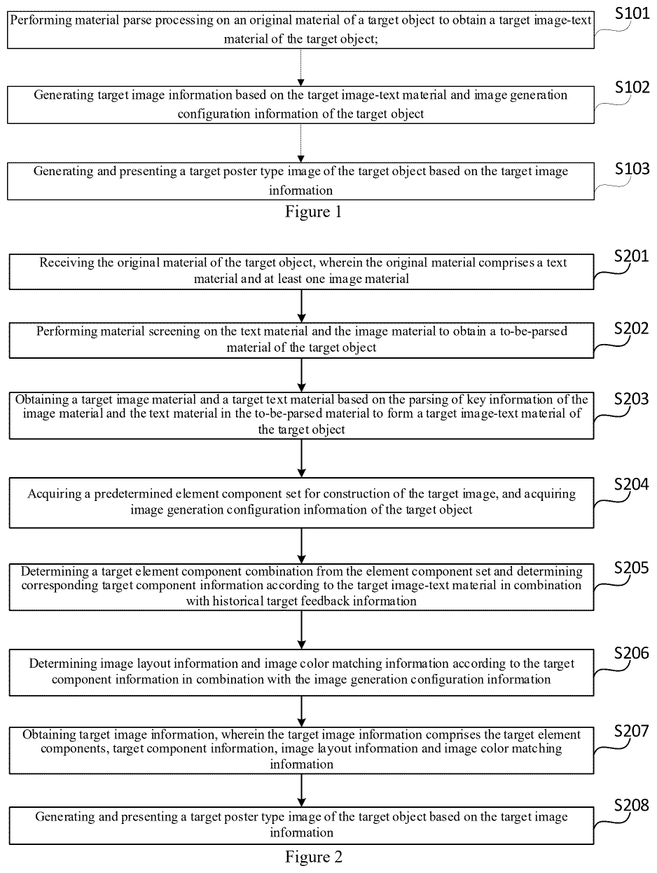

As an optional embodiment of the present embodiment, on the basis of the above-mentioned embodiment, the present optional embodiment can further optimize the above-mentioned image generation method. Specifically, FIG. 2 shows a schematic flow diagram of another image generation method provided by an embodiment of the present disclosure. As shown in FIG. 2, the image generation method can specifically include the following steps.

The following S201 to S203 in the present embodiment give a specific implementation of performing material parse processing on an original material of a target object to obtain a target image-text material of the target object.

S201: receiving the original material of the target object, wherein the original material comprises a text material and at least one image material.

In the present embodiment, the demand side of poster type image generation can upload the original material related to the target object, and in this step, the original material of the target object uploaded by the demand side through human-computer interaction can be received. Illustratively, the original material can include a text material formed by text information describing the functions, characteristics, and other attributes of the target object, and can also include an image material formed by image information presenting the form of the target object by using a plurality of images from different perspectives and different levels.

In the present embodiment, by taking a certain business product as an example of the target object, the received original material can contain text information as the title of the business product, and the text information can contain the name, capacity/weight, product efficacy, and the like of the business product. The original material can also include text information to introduce the category of the business product. Meanwhile, the original material also includes a plurality of images related to the business product. The plurality of images can contain a main image and a header image that are mainly images of the business product, and can also include a product detail image that is mainly the product introduction.

S202: performing material screening on the text material and the image material to obtain a to-be-parsed material of the target object.

In the present embodiment, considering that the original material contains many and miscellaneous images and texts, it is possible to perform preliminary screening on the original material through this step after receiving the original material, and the remaining material after screening is recorded as the to-be-parsed material.

Illustratively, the process of performing preliminary screening on the original material in this step can be described as: screening the image material based on key information in the text information, screening out the images that do not contain the key information, performing similarity calculation on the images in the original material, screening out the images with too high similarity, and also screening out the images that are mainly text description. The present embodiment does not specifically limit the screening rules in this step, as long as it can ensure that the to-be-parsed element obtained after screening contains the text material of key text information and the image material of the specific form of the business product.

It should be noted that when the original material contains a plurality of image materials, the to-be-parsed material after the preliminary screening also contains at least one image material.

S203: obtaining a target image material and a target text material based on the parsing of key information of the image material and the text material in the to-be-parsed material to form a target image-text material of the target object.

In the present embodiment, it is possible to perform parse processing on the image material by image feature extraction, image recognition, cutout and other algorithms, so as to obtain the cut-out image containing key information of the business product. In this step, it is also possible to perform parse processing on the text material by text recognition, keyword extraction, and other algorithms, so as to obtain key text information. In the present embodiment, the image result formed after image processing is recorded as the target image material, and the text result formed after text processing is recorded as the target text material.

In the above-mentioned specific implementation of determining the target image-text material, the preliminary screening on the image-text material among the original materials is considered before the material parse is performed. Through the preliminary screening, it is possible to screen out the materials with low relevance to the target object, and it is also possible to screen out the materials with high repetition rate, so as to simplify the number of materials involved in the material parse processing, reduce the occupation of computing resources in the material processing stage, and also reduce the influence of unrelated materials on the subsequent poster generation.

On the basis of the above-mentioned embodiment, in the present optional embodiment, the obtaining the target image material and the target text material based on the parsing of key information of the image material and the text material in the to-be-parsed material to form a target image-text material of the target object can be further optimized to the following steps.
a1) performing image recognition and cutout processing on the image material in the to-be-parsed material to obtain at least one candidate cutout result.

In the present embodiment, through this step, it is possible to perform image recognition on each image material in the to-be-parsed material by means of feature extraction and the like, so as to recognize a key image area containing the target object and other contents from the image material, and then perform cutout processing on the key image area by a cutout algorithm, thereby to obtain at least one candidate cutout result.

It should be known that the present embodiment can be considered that the recognition object is known before image recognition. This recognition object can be considered as key information related to the target object, which can be pre-input to-be-recognized information. Alternatively, the target object can be directly used as the to-be-recognized information. The present embodiment does not specifically limit the implementation of image recognition.

Following the above-mentioned description, after the image area which is determined to contain the to-be-recognized content is recognized from the image material, the image area can be cut out from the image material through the cutout algorithm. The present embodiment does not specifically limit the cutout processing algorithm adopted. The cut-out image obtained by cutting out the image area can be taken as a candidate cutout result corresponding to the material parse processing. At least one candidate cutout result can be obtained in this step.
b1) screening the candidate cutout results according to set screening conditions, and taking the target cutout result after screening as the target image material.

In the present embodiment, in case if one candidate cutout result is obtained, it is possible to directly take the candidate cutout result as the target image material; in case if two or more candidate cutout results are obtained, it is necessary to screen the candidate cutout results through this step, by which the candidate cutout results that meet the screening conditions are screened out to obtain the target cutout result.

It should be known that the candidate cutout results obtained by the above-mentioned cutout processing are not necessarily suitable to be used as the element contents in the poster type images. For example, some candidate cutout results may be incomplete, some candidate cutout results may not meet the conditions for resolution, and some candidate cutout results may not meet the requirements for cutout edge smoothness, and etc.

In the present embodiment, some constraint information contained in the image generation configuration information of the target object can be included to assist the generation of the screening conditions in this step, and the screening condition can include a screening item that limits the aspect ratio of the candidate cutout result, a screening item that limits the resolution of the candidate cutout result or the clarity of the target object contained, a screening item that limits the cutout completeness of the candidate cutout result, a screening item that limits the cutout edge smoothness of the candidate cutout result, and etc.

In a specific implementation of this step, it is possible to score each candidate cutout result with respect to the screening items of the screening condition to obtain a scoring value of each candidate cutout result with respect to each screening item, and then take the sum of the scoring values for each of the screening items as a total score of the candidate cutout result. Then, the candidate cutout results can be sorted by the total score from high to low, and finally the top candidate cutout result can be taken as the target cutout result, and recorded as the target image material of the present embodiment.

In the present embodiment, it is possible to preset a scoring information table with respect to each screening item, and determine the scoring value of the candidate cutout result with respect to each screening item by looking up in the scoring information table. It should be noted that the selected candidate cutout result after scoring and sorting may still need to be clipped. In the present embodiment, the size of the candidate cutout result can be fine-tuned by clipping so as to adapt to the different generation requirements of the poster type images, and the fine-tuned candidate cutout result can be taken as the target image material.
c1) performing keyword extraction on the text material in the to-be-parsed material to obtain a target text material, and forming a target image-text material comprising the target image material and the target text material.

In the present embodiment, this step is mainly to perform parse processing on the text material in the to-be-parsed material, specifically, it is to perform keyword extraction on the text material. The keyword extraction can be realized by a pre-trained text feature extraction model, and the output result of the model can be taken as the target text material in this step.

In the present embodiment, the recognized attribute information such as the name and efficacy of the target object can be taken as keywords in the implementation of keyword extraction. In the present embodiment, the target image material and the target text material determined through the above-mentioned steps can be recorded as the target image-text material of the target object.

Illustratively, taking a business product as an example of the target object, based on the parsing of the original material corresponding to the business product, the target cut-out image with the highest total score can be determined from a plurality of cut-out images containing the business product. The target cut-out image can be taken as the target image material, and its size, resolution, cutout edge smoothness and the like have the highest scores. The target cut-out image clearly shows the image content related to the business product, such as the front image of the business product, the side image of the business product and the packaging image of the business product.

Following the above-mentioned description, by performing key text extraction on the text material after the preliminary screening of the original material of the business product, the extracted key text can contain the name and effect descriptive text of the business product. Meanwhile, it can be known that it is also possible in the present embodiment to provide an available text from the image material through the text recognition technologies, and take the available text as a part of the target text material so as to enrich the material information.

The above-mentioned technical solution gives a specific implementation of determining the target image-text material, and the core of the determination is to determine the key content related to the target object from the image material and the text material by means of recognition, cutout, feature extraction and the like. The above-mentioned technical solution provides key data information and gives key data support for the generation of poster type image.

In the present embodiment, the following S204 to S206 give a specific implementation of generating target image information based on the target image-text material and image generation configuration information of the target object.

S204: acquiring a predetermined element component set for construction of the target image, and acquiring image generation configuration information of the target object.

It should be noted that, regarding the generation of the poster type image, it is necessary in the present embodiment to know in advance what element contents should be included in the poster type image. In addition to the necessary image-text elements related to the target object, it is also necessary to contain some decorative elements and background elements. In the present embodiment, an element component set can be predetermined, which includes different types of element component materials, such as a plurality of background types of element component materials, and a plurality of decorative types of element component materials.

In the present embodiment, various types of different element component materials contained in the element component set can be used for construction of the poster type image of any target object, and the contents in the element component set can be updated according to the set update strategy. It is believed in the present embodiment that the element component set can meet the basic requirements for the poster type image generation.

In this step, it is also possible to acquire the image generation configuration information for the corresponding target object in addition to the element component set, and the image generation configuration information can be input in advance by the demand side of the poster type image generation by means of information editing, and received by the executive body of the present embodiment. The image generation configuration information can include a poster type image size, a poster type image resolution, and the like expected by the demand side.

S205: determining a target element component combination from the element component set and determining corresponding target component information according to the target image-text material in combination with historical target feedback information.

In the present embodiment, the determination of the target element component and the target element information can be considered as the determination of the creative element strategy in poster type image generation. Also, as the key information of poster type image generation, it contains creative guidance information, which can be used for guiding which element components need to be contained in the to-be-generated poster and in what way the contained element components need to be combined to form the poster type image. The element components to be contained can be taken as the target element component combination, and the related information describing the combination form of the element components in the target element component combination can be considered as the target component information corresponding to the target element component combination.

For the determination of the target element component combination and the target component information, in one implementation of the present embodiment, it is possible to select the element components that should be included in the poster type image corresponding to the target object from the element component set based on the target image-text material to form the target element component combination. Meanwhile, it is also possible to determine the component-related information such as how to combine these element components, what the layout style is, and what attribute information each element component has. In the present embodiment, the component-related information is recorded as the target component information corresponding to the target element component combination. In this implementation, the matching degree of the element components when they are combined with the target image-text material to form a poster type image is mainly considered, such as selecting decorative elements with a similar style to the target image material from the element component set, selecting background elements that can highlight the target image material from the element component set, how to determine the layout style of the target image material and the target text material, and etc.

In the above-described manner, although it is possible to determine which target element components can be specifically contained in the to-be-generated poster type image and the target component information that describes these target element components, this implementation mainly considers the influence of the target image-text material on the target component information, which mainly reflects that the target element component combination is determined and the target component information is obtained in a manner of free combination without template under the prerequisite constraint condition of the target image-text material.

Although the above-mentioned implementation can basically ensure flexibility and novelty of presentation of elements of the generated poster type image, it cannot ensure that the quality of the generated poster type image is also good. The quality of the generated poster type image will also influence the subsequent publicity and spreading effects of the target object.

It should be known that the quality of the poster type image can be judged by using the feedback information after the launch of the poster type image. If the sales quota related to the target object is obviously improved after the launch of the poster type images generated for the corresponding target object, it can be considered that the poster type image is accepted by consumers, and it can be also considered that the quality of the poster type image is good. Based on the above-mentioned description, the present embodiment considers to take the feedback information after the launch of the historical target image as the constraint information for determining the target element component and the target component information.

Specifically, this step gives another manner to determine the target element component combination and target component information, which not only depends on the target image-text material, but also considers the historical target feedback information collected after the launch of the historical target images. Based on the historical target feedback information, how well consumers or publicity objects accept the historical target images is clear. The historical target images can be considered as generated poster type images corresponding to other target objects belonging to the same vertical category as the target object. The feedback information collected after the launch of this kind of historical target images can be recorded as the historical target feedback information associated with this target object.

In the present embodiment, in the process of selecting the target element components from the element component set and generating the target component information, it is possible to first determine a plurality of element components, with respect to different element types, better matching the target image-text material from the element component set by using the target image-text material, and it is also possible to determine various suitable image-text layout formats to form different target component information. Then, it is possible to obtain, by screening, the element components, with respect to different element types, most suitable for the target object from the previously determined plurality of elements to form a target element component combination based on the historical target feedback information. Finally, for the obtained most suitable target element component combination, it is possible to use descriptive information such as an image-text layout format with the best feedback effect to form the corresponding target component information.

Illustratively, in the present optional embodiment, the determining the target element component combination from the element component set and determining corresponding target component information according to the target image-text material in combination with historical target feedback information can be further optimized to the following steps.
a2) analyzing the target image-text material to determine corresponding target vertical category information and image-text feature information.

This step mainly realizes the analysis of the target image-text material, and the vertical category of the target object can be determined from the key text information contained in the target text material, and recorded as target vertical category information. The vertical category can be understood as information formed by performing field division and classification based on a vertical angle, and users in the same vertical category field can be considered to have similar needs, hobbies, and etc.

Meanwhile, it is also possible in this step to obtain the image-text feature information contained in the target image-text material by analyzing it, which can be realized in a manner of, e.g. feature extraction. The image-text analysis manner is not specifically limited by the present embodiment.
b2) screening element components in the element component set according to the target vertical category information and image-text feature information to obtain at least one element component combination and corresponding component information.

In the present embodiment, it can be known that the element materials under different element types which can be used for generating the poster type image are collected in the element component set, and are recorded as element components in the present embodiment. From the target vertical category information and image-text feature information, it is possible to determine which element types of element components should be included in the to-be-generated poster type image to be generated with respect to the corresponding target object, and later it is also possible to select element components matching the target image-text material from the element materials under different element types, and it is also possible to determine the combination forms that different element components should have when they are involved in the poster type image generation.

Based on the above-mentioned logic, it is possible to obtain at least one element component combination, each of which contains the element components required in this combination(such as which decorative element components are used, which background element components are used). It is also possible to obtain the component information corresponding to each element component combination, and the component information mainly includes descriptive information describing information such as the layout format of the element components in the element component combination, size and position occupied by the image material and text material, and the like.
c2) determining a target element component combination from the element component combinations according to the historical target feedback information monitored after the launch of a historical target image, and taking the corresponding component information as the target component information.

In the present embodiment, it is possible in this step to screen the element component combinations based on the above-acquired historical target feedback information, thereby to obtain the combination with the best feedback effect. This combination can be recorded as the target element component combination. The target element component combination contains the target element components required for target image generation, and the target element components can be considered as element components to be included in the to-be-generated poster type image. While obtaining the target element component combination, it is possible to obtain the component information of the target element component combination, which is recorded as the target component information in the present embodiment. The target component information can be considered as a descriptive file describing the information required for poster generation, such as the combination form and combination position of the target element components in the target element component combination.

The above-mentioned technical solution of the present embodiment gives a specific implementation of determining the required target element components and target component information in the process of generating target image information. The above-mentioned technical solution realizes a flexible combination of element components under the vertical category to which the target object belongs, and also realizes the control of the combination quality after the flexible combination of element components by using historical feedback information. Through the above-mentioned operations, the limitations of the to-be-generated image are reduced, and the generation quality of the to-be-generated image can also be improved.

S206: determining image layout information and image color matching information according to the target component information in combination with the image generation configuration information.

In the present embodiment, the above-determined target component information can be considered as creative strategy information on which poster type image generation depends. The target component information mainly describes the layout form among the target element components contained in the corresponding target element component combination, and also describes the fuzzy position where the target element components in the form of text or image are located, as well as the element attribute information related to each target element component, and etc. If the poster type image generation is performed only based on the target component information, it is impossible to ensure that the poster type image is obtained as expected by the demand side.

In order to ensure that the generated poster type image meets the expectations of the demand side, the present embodiment forms the constraint conditions of poster generation based on the image generation configuration information in this step, so as to obtain the image layout information and image color matching information which makes a constrained description of the layout information and color matching information on which the poster generation depends.

In the present embodiment, the image layout information can be specifically understood as a descriptive file containing image-text layout format information, image-text position information and image-text occupied area size information. The image color matching information can be understood as a descriptive file containing color information such as hue, saturation and brightness of images and texts. In the specific implementation of information determination, it is possible to first generate the constraint conditions according to the image generation configuration information, and later determine what kind of constraints the corresponding element components will have from the element attribute information in the target component information, thereby to determine the specific position information, occupied length and width, and the like of the element components based on the constraint conditions to be complied.

Similarly, it is also possible to first determine the color information of the main image in the poster according to the constraint requiring color harmony among the constraint conditions, and then adjust the color attribute of the target element components according to the color information of the main image, so that the adjusted color of the target element components match the main color.

Illustratively, in the present optional embodiment, the determining image layout information and image color matching information according to the target component information in combination with the image generation configuration information further specifically include the following step:
a3) extracting element attribute information of target element components in a corresponding target element component combination from the target component information.

In the present embodiment, after determining the target element component combination, it is possible to extract those target element components contained, and obtain the element attribute information of each target element component based on the target component information corresponding to the target element component combination. The target element components can specifically include the target image-text material, decorative elements, background elements, etc. The element attribute information of each target element component can include the element type, the element color, the area proportion of the element component, the relative relationship among the element components, and etc.
b3) determining image layout information of the target element components in a to-be-generated image according to the element attribute information and the image generation configuration information.

In the present embodiment, image generation constraint conditions can be determined from the image generation configuration information, and the constraint conditions can define the color matching requirements, layout requirements, resolution requirements and the like of poster type images in the to-to-generated image. These poster constraint conditions have constraint conflicts with respect to different target element components. In order to ensure that the constraint conditions can be met and the constraint conflicts can be reduced as far as possible, priorities for different target element components can be set, and then the constraint conditions of the target element component with high priority can be satisfied first according to the priority, and the layout information after balancing constraint conflicts can be finally obtained as the image layout information of the present embodiment.

In the present embodiment, the determining image layout information of the target element component in a to-be-generated image according to the element attribute information and the image generation configuration information can also be specifically optimized to the following steps:
b31) performing component classification on the target element components to obtain at least one type of element components.

In the present embodiment, it is possible to specifically perform component classification on the target element components in the target element component combination. The component classification can performed according to the element type to which the target element components belong, and finally at least one type of element components can be obtained. Illustratively, the element types can include canvases, text boxes, product drawings, decorations, etc. In the present embodiment, the target element components can be classified according to these element types.
b32) determining processing priority of each type of element components, and analyzing the image generation configuration information to determine image generation constraint conditions.

In the present embodiment, different element types have different processing priorities. Illustratively, the canvas can be set with the highest priority, followed by the product drawings, then the text boxes, and finally the decorations. In this step, it is possible to analyze the image generation configuration information, thereby to acquire the information that constrains the layout and color matching, which constitutes the image generation constraint conditions in the present embodiment.
b33) determining the image layout information of the target element components in the to-be-generated image according to the processing priority in combination with the element attribute information and the image generation constraint conditions.

In the present embodiment, the image generation constraint conditions can constrain and standardize the image layout, text size, position, spacing and the like. In this step, it is possible to calculate the size and relative spacing of each target element component according to the content described in the element attribute information corresponding to each target element component, thereby to obtain more elaborate layout information.

Considering that the superposition of a plurality of constraint conditions will lead to constraint conflicts, when performing the above-mentioned logical operations in this step, it is possible to set processing priority to first ensure the constraint requirements of the target element component with the highest priority according to the processing priority. In one implementation, it is possible to transform the image generation constraint conditions into different equality and inequality constraints according to the processing priority, and then use the linear constraint algorithm to calculate the optimal solution. The solution result can be taken as the layout description of different target element components in the present embodiment, and recorded as image layout information.

Illustratively, the image layout information can give the specific presentation position of the image-text material in the poster type image, as well as the specific sizes of texts and images, and etc.

The above-mentioned technical solution gives the specific determination implementation of image layout information. Through the above-mentioned step, it is possible to ensure that the image layout information better meets the requirements of the demand side while ensuring the free combination of poster elements.
c3) updating color attribute information of element attribute information corresponding to the target element components as image color matching information of the target element components according to color information of the target image material in the target image-text material.

In the present embodiment, it is possible to determine the image color matching information through this step while determining the image layout information through the above-mentioned step b3 or after determining the layout. It can be known that the color information of the target image material in the target image-text material is taken as the core color information in the to-be-generated poster type image, and the image generation configuration information can contain constraints on color matching information, for example, it is possible to require color harmony and hue consistency of each of the element components in the poster.

Therefore, when determining the image color matching information in this step, it is possible to update the color information of other target element components with the color information of the target image material as the main color based on the color matching constraint content, and this color information can be considered as existing in the element attribute information corresponding to the target element components. Thus, updating the color information is equivalent to updating the color attribute information of the element attribute information, and the updated color attribute information can be taken as the image color matching information of the present embodiment.

In addition to the above-mentioned color harmony processing on the image material, it is also possible to use the main color of the target image material to perform color matching processing on the text hue of the target text material. Illustratively, it is possible to adjust the brightness and saturation of the text according to the color of the background element area where the text is located, so as to enhance the contrast and impact of the text.

Illustratively, the present implementation can also optimize the updating color attribute information of element attribute information corresponding to the target element component as image color matching information of the target element component according to color information of the target image material in the target image-text material to specifically include the following steps.
C31) clustering colors contained in the target image material in the target image-text material to determine a core color of the target image material.

In the present embodiment, it is possible to take the target image material as the main image of the to-be-generated image. The core color of the target image material can be obtained by means of color clustering in this step, and the core color can also be considered as the core color of the to-be-generated image. This step realizes intelligent color selection of colors corresponding to the poster type image in the determination of color matching information.
c32) projecting the core color into HSV (Hue, Saturation, Value) color space to obtain angle information of the projected core color on a color wheel, and determining a target angle range based on the angle information.

In the present embodiment, the core color is preferably represented by RGB (Red, Green, Blue) color space. In this step, the RGB color space of the core color can be projected into HSV color space, and thus related color values such as hue, saturation and lightness corresponding to the core color can be obtained. It should be noted that the HSV color space can be considered as a hexagonal pyramid model space according to the intuitive characteristics of colors. The color space mainly uses angles to measure hue, and uses numerical values between 0 and 1 to represent saturation and lightness, and the hue measured by angles can be embodied in the form of a color wheel.

Based on the above-mentioned description, in this step the corresponding angle information on the color wheel after projection can be obtained, and the angle information can be a specific angle value. However, through the theoretical setting of HSV color space, the specific angle value can fall within an angle range, which is recorded as the target angle range in the present embodiment.
c33) adjusting color attributes of the target element components until the angle information obtained after projecting the color information corresponding to the target element components into the HSV color space is within the target angle range.

In the present embodiment, the element attribute information of the target element components contains their corresponding color attribute, and a description of color information in the color attribute is also a representation in RGB color space. In this step, it is also necessary to project the color information corresponding to each target element component into HSV color space and obtain its angle information in HSV color space.

It can be known that the angle information may not be in the target angle range, and in this step, it is possible to adjust the angle of the target element components so that the adjusted angle information is also in the target angle range. In this step, it is also possible to restore the adjusted angle information into RGB color space, thereby to obtain the adjusted color information of the corresponding target element component, and further constitute the adjusted color attribute of the target element component.

It should be noted that in this step, in addition to ensuring color harmony by adjusting the hue, it is also possible to use some gradient color pairs to realize the gradient presentation of background element components. Illustratively, it is possible to find the gradient color execution logic matching the core color from a pre-built gradient color pair information table, and adjust the color attribute of the background element components through the gradient color execution logic.
c34) acquiring the adjusted color attribute information as the image color matching information of the target element components.

In this step, the adjusted color attribute information can be taken as the image color matching information of the corresponding target element component.

The execution of the above-mentioned two steps in the present embodiment can ensure the color harmony of the element components contained in the to-be-generated image, so that the to-be-generated image can have a comfortable visual feeling. In addition, the gradient color induced by color adjustment can also play a role in guiding the unique atmosphere, and can also be used to improve the visual appeal of the generated poster type image.

In addition, the technical implementation of the above-mentioned steps a3) to step c3) in the present embodiment also provides the process of determining image layout information and image color matching information. As the key descriptive information of poster type image generation, the determined image layout information and image color matching information can ensure that the generated poster type image has a more novel visual effect.

S207: obtaining target image information, wherein the target image information comprises the target element components, target component information, image layout information and image color matching information.

In the present embodiment, it is possible to obtain the above-mentioned determined target element components and the corresponding target component information, as well as the image layout information and image color matching information. In this step, it is possible to form target image information based on the above-obtained target element components and various descriptive information required for image generation, such as target component information related to the target element components, the image layout information and image color matching information related to the overall image presentation.

S208: generating and presenting a target poster type image of the target object based on the target image information.

In the present embodiment, it is possible to superimpose each target element component (such as a canvas element component, text box element component, target image-text material and decoration) in the target image information in a certain order with a specified size, a specified position and a specified color, according to the image layout information, image color matching information and target component information in the target image information, so as to synthesize a whole image and output it as the target image of the present embodiment.

It can be known that the target poster type image generated by rendering the target image information can be used to publicize and promote the target object offline or online, which can better realize the publicity of the target object on the basis of saving labor cost. The target poster type image determined by the above-mentioned image generation method realizes the flexible and effective selection of the target object image in poster type image generation, and also provides the determination of the poster creative strategy of a free combination without template, which ensures the diversified derivation of the poster creative strategy. The poster type image generated by the above-mentioned means can achieve the effect of better fitting the target object, improve the generation efficiency, reduce the limitations of the content presented by poster type image and improve the generation quality.

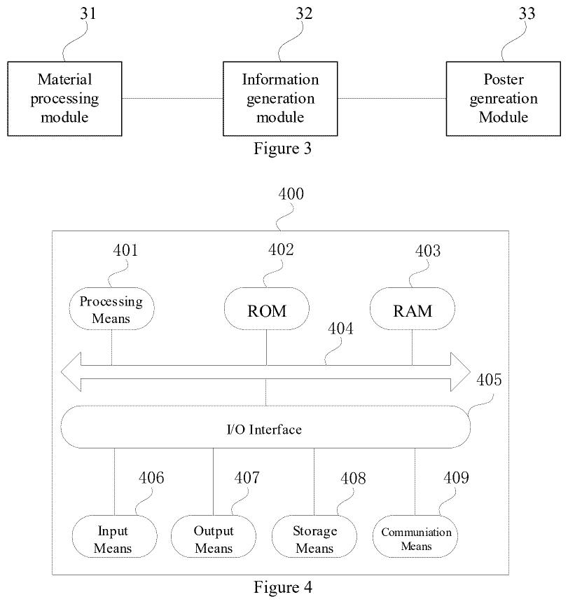

FIG. 3 is a schematic structural diagram of an image generating apparatus provided by an embodiment of the present disclosure. As shown in FIG. 3, the apparatus includes: a material processing module 31, an information generation module 32 and a poster generation module 33, wherein,
the material processing module 31 is used for performing material parse processing on an original material of a target object to obtain a target image-text material of the target object;
the information generation module 32 is used for generating target image information based on the target image-text material and image generation configuration information of the target object;
the poster generation module 33 is used for generating and presenting a target poster type image of the target object based on the target image information.

An image generation apparatus provided by the embodiment of the present disclosure can realize the automatic generation of the poster type image. Compared with the existing manually designed posters based on professional designers, this technical solution greatly reduces the cost of poster generation and improves the efficiency of poster generation. In the implementation of the whole technical solution, the selection of the image-text material required for poster production of the target object is realized by means of material parse processing, and the determination of key information required for poster production is realized by means of generating target image information matching the corresponding target object. The poster type image generated by the above-mentioned means can achieve the effect of better fitting the target object, improve the generation efficiency while reducing the limitations of the content presented by the poster type image, and improve the generation quality.

Further, the material processing module 31 can specifically include:
a material receiving unit for receiving the original material of the target object, wherein the original material comprises a text material and at least one image material;
a material screening unit for performing material screening on the text material and the image material to obtain a to-be-parsed material of the target object;
a material parsing unit for obtaining a target image material and a target text material based on the parsing of key information of the image material and the text material in the to-be-parsed material to form a target image-text material of the target object.

Further, the material parsing unit can be specifically used for:
performing image recognition and cutout processing on the image material in the to-be-parsed material to obtain at least one candidate cutout result;
screening the candidate cutout results according to set screening conditions, and taking the target cutout result after screening as a target image material;
performing keyword extraction on the text material in the to-be-parsed material to obtain a target text material, and forming a target image-text material comprising the target image material and the target text material.

Further, the information generation module can specifically include:
an information acquiring unit for acquiring a predetermined element component set for construction of the target image, and acquiring image generation configuration information of the target object;
an element determining unit for determining a target element component combination from the element component set according to the target image-text material in combination with historical target feedback information,;
an information determining unit for determining image layout information and image color matching information and determining corresponding target component information according to the target component information in combination with the image generation configuration information;
an obtaining module for obtaining target image information, wherein the target image information comprises the target element component combination, target component information, image layout information and image color matching information.

Further, the element determining unit can be specifically used for:
analyzing the target image-text material to determine corresponding target vertical category information and image-text feature information;
screening element components in the element component set according to the target vertical category information and image-text feature information to obtain at least one element component combination and corresponding component information;
determining a target element component combination from the element component combinations according to the historical target feedback information monitored after the launch of a historical target image, and taking the corresponding component information as the target component information.

Further, the information determining unit can specifically include:
an extracting subunit for extracting element attribute information of the target element components in the corresponding target element component combination from the target component information;
a first determining subunit for determining image layout information of the target element components in a to-be-generated image according to the element attribute information and the image generation configuration information;
a second determining subunit for updating color attribute information of element attribute information corresponding to the target element components as image color matching information of the target element components according to color information of the target image material in the target image-text material.

Further, the first determining subunit can be specifically used for:
performing component classification on the target element components to obtain at least one type of element components;
determining processing priority of each type of element components, and analyzing the image generation configuration information to determine image generation constraint conditions;
determining the image layout information of the target element components in the to-be-generated image according to the processing priority in combination with the element attribute information and the image generation constraint conditions.

Further, the second determining subunit can be specifically used for:
clustering colors contained in the target image material in the target image-text material to determine a core color of the target image material;
projecting the core color into HSV color space to obtain angle information of the projected core color on a color wheel, and determining a target angle range based on the angle information;
adjusting color attributes of the target element components until the angle information obtained after projecting the color information corresponding to the target element components into the HSV color space is within the target angle range;
acquiring the adjusted color attribute information as the image color matching information of the target element components.

The image generating apparatus provided by the embodiment of the present disclosure can execute the image generation method provided by any embodiment of the present disclosure, and has corresponding functional modules and beneficial effects for execution of the method.

It is worth noting that the units and modules included in the above-mentioned apparatus are only divided according to functional logic, but are not limited to the above division, as long as the corresponding functions can be realized. In addition, the specific names of the functional units are only for the convenience of distinguishing each other, and are not used to limit the protection scope of the embodiments of the present disclosure.

FIG. 4 is a schematic structural diagram of an electronic device provided by an embodiment of the present disclosure. Reference is now made to FIG. 4, which shows a schematic structural diagram of an electronic device (such as a terminal device or a server in FIG. 4) 400 suitable for implementing the embodiment of the present disclosure. The terminal device in the embodiment of the present disclosure can include, but is not limited to, mobile terminals such as mobile phones, notebook computers, digital broadcast receivers, Personal Digital Assistants (PDAs), Tablet Computers (PADs), Portable Media Players (PMPs), vehicle-mounted terminals (such as vehicle-mounted navigation terminals), as well as fixed terminals such as digital TV and desktop computers. The electronic device shown in FIG. 4 is only an example, and should not bring any limitation to the functions and application scope of the embodiment of the present disclosure.

As shown in FIG. 4, the electronic device 400 can include a processing means (such as a central processing unit, or a graphical processor) 401, which can execute various appropriate actions and processes according to programs stored in a Read-Only Memory (ROM) 402 or programs loaded from a storage means 408 into a Random Access Memory (RAM) 403. In the RAM 403, various programs and data required for the operation of the electronic means 400 are also stored. The processing means 401, the ROM 402 and the RAM 403 are connected to each other through a bus 404. An edit/output (I/O) interface 405 is also connected to the bus 404.

Generally, the following means can be connected to the I/O interface 405: an input means 406 including, for example, a touch screen, a touch pad, a keyboard, a mouse, a camera, a microphone, an accelerometer, and a gyroscope; an output means 407 including, for example, a Liquid Crystal Display, LCD), a speaker, and a vibrator; a storage means 408 including, for example, a magnetic tape, and a hard disk; and a communication means 409. The communication means 409 can allow the electronic device 400 to perform wireless or wired communication with other devices to exchange data. Although FIG. 4 shows an electronic device 400 with various means, it should be understood that it is not required to implement or provide all the means shown. More or fewer means can alternatively be implemented or provided.

In particular, according to an embodiment of the present disclosure, the process described above with reference to the flow diagram can be implemented as a computer software program. For example, an embodiment of the present disclosure includes a computer program product including a computer program carried on a non-transitory computer readable medium, and the computer program contains program codes for executing the method shown in the flow diagram. In such an embodiment, the computer program can be downloaded and installed from the network through the communication means 409, or installed from the storage means 408, or installed from the ROM 402. When the computer program is executed by the processing means 401, the above-mentioned functions defined in the method of the embodiment of the present disclosure are performed.

Names of messages or information exchanged among the plurality of means in the implementation of the present disclosure are only used for illustrative purposes, and are not used to limit the scope of these messages or information.

The electronic device provided by the embodiment of the present disclosure belongs to the same inventive concept as the image generation method provided by the above-mentioned embodiment, and the technical details not described in detail in the present embodiment can be found in the above-mentioned embodiment, and the present embodiment has the same beneficial effects as the above-mentioned embodiment.

An embodiment of the present disclosure provides a computer storage medium storing thereon a computer program which, when executed by a processor, implements the image generation method provided in the above-mentioned embodiment.

It should be noted that the above-mentioned computer readable medium in the present disclosure can be a computer readable signal medium or a computer readable storage medium or any combination of the two. The computer readable storage medium can be, for example, but not limited to, an electrical, magnetic, optical, electromagnetic, infrared, or semiconductor system, apparatus or device, or a combination of any of the above. More specific examples of the computer readable storage medium can include, but are not limited to, an electrical connection with one or more wires, a portable computer disk, a hard disk, a Random Access Memory (RAM), a Read-Only Memory (ROM), an Erasable Programmable ROM (EPROM or flash memory), an optical fiber, a portable Compact Disc ROM (CD-ROM), an optical storage device, a magnetic storage device, or any suitable combination of the above. In the present disclosure, the computer readable storage medium can be any tangible medium containing or storing programs, which can be used by or in combination with an instruction execution system, apparatus or device. In the present disclosure, the computer readable signal medium can include a data signal propagated in baseband or as part of a carrier wave, in which computer readable program codes are carried. This propagated data signal can take many forms, including but not limited to an electromagnetic signal, an optical signals or any suitable combination of the above. The computer readable signal medium can also be any computer readable medium other than the computer readable storage medium, which can send, propagate or transmit a program for use by or in connection with an instruction execution system, apparatus or device. The program codes contained in the computer readable medium can be transmitted by any suitable medium, including but not limited to: wires, optical cables, RF(Radio Frequency), etc., or any suitable combination of the above.

In some implementations, clients and servers can communicate by using any currently known or future developed network protocol such as HyperText Transfer Protocol (HTTP), and can be interconnected with digital data communication in any form or medium (for example, communication network). Examples of the communication network include a Local Area Network (“LAN”), a Wide Area Network (“WAN”), the Internet (for example, the Internet) and end-to-end networks (for example, ad hoc end-to-end networks), as well as any currently known or future developed networks.

The above-mentioned computer readable medium can be contained in the above-mentioned electronic device, or it can exist alone without being assembled into the electronic device.

The above-mentioned computer readable medium carries one or more programs, which, when executed by the electronic device, cause the electronic device to: perform material parse processing on an original material of a target object to obtain a target image-text material of the target object; generate target image information based on the target image-text material and image generation configuration information of the target object; generating and presenting target poster type images of the target object based on the target image information.

Computer program codes for performing the operations of the present disclosure can be written in one or more programming languages or a combination thereof, including but not limited to object-oriented programming languages, such as Java, Smalltalk, C++, as well as conventional procedural programming languages, such as “C” language or similar programming languages. The program codes can be completely executed on a user computer, partially executed on the user computer, executed as an independent software package, partially executed on the user computer and partially executed on a remote computer, or completely executed on the remote computer or a server. In the case involving a remote computer, the remote computer can be connected to a user computer through any kind of network, including a local area network (LAN) or a wide area network (WAN), or can be connected to an external computer (for example, through the Internet using an Internet service provider).

The flow diagrams and block diagrams in the drawings illustrate the architecture, functions and operations of possible implementations of the system, method and computer program product according to various embodiments of the present disclosure. In this regard, each block in the flow diagrams or block diagrams can represent a module, a program segment, or a part of codes that contain one or more executable instructions for implementing specified logical functions. It should also be noted that in some alternative implementations, the functions noted in the blocks can occur in a different order than those noted in the drawings. For example, two blocks shown in succession can actually be executed substantially in parallel, and they can sometimes be executed in the reverse order, depending on the functions involved. It should also be noted that each or a combination of blocks in the block diagrams and/or flow diagrams can be implemented by a dedicated hardware-based system that performs specified functions or operations, or by a combination of dedicated hardware and computer instructions.

The involved units described in the embodiments of the present disclosure can be implemented by software or hardware. The name of the unit does not constitute the limitation of the unit itself in some cases. For example, the first acquiring unit can also be described as “the unit that acquires at least two Internet protocol addresses”.

The functions described above herein can be at least partially performed by one or more hardware logic components. For example, without limitation, exemplary types of hardware logic components that can be used include: a Field-Programmable Gate Array (FPGA), an Application-Specific Integrated Circuit (ASIC), Application Specific Standard Product (ASSP), a System on Chip (SOC), a Complex Programmable Logic Device (CPLD) and etc.

In the context of the present disclosure, a machine readable medium can be a tangible medium that can contain or store a program for use by or in connection with an instruction execution system, apparatus or device. The machine readable medium can be a machine readable signal medium or a machine readable storage medium. The machine readable medium may include, but is not limited to, an electronic, magnetic, optical, electromagnetic, infrared, or semiconductor system, apparatus or device, or any suitable combination of the above. More specific examples of the machine readable storage medium will include an electrical connection based on one or more wires, a portable computer disk, a hard disk, a Random Access Memory (RAM), a Read-Only Memory (ROM), an Erasable Programmable ROM (EPROM or flash memory), an optical fiber, a portable Compact Disc ROM (CD-ROM), an optical storage device, a magnetic storage device, or any suitable combination of the above.

According to one or more embodiments of the present disclosure, [Example 1] provides an image generation method, which comprises:
performing material parse processing on an original material of a target object to obtain a target image-text material of the target object;
generating target image information based on the target image-text material and image generation configuration information of the target object;
generating and presenting a target poster type image of the target object based on the target image information.

According to one or more embodiments of the present disclosure, [Example 2] provides an image generation method, wherein the performing material parse processing on an original material of a target object to obtain a target image-text material of the target object can comprise:
receiving the original material of the target object, wherein the original material comprises a text material and at least one image material;
performing material screening on the text material and the image material to obtain a to-be-parsed material of the target object;
obtaining a target image material and a target text material based on the parsing of key information of the image material and the text material in the to-be-parsed material to form a target image-text material of the target object.

According to one or more embodiments of the present disclosure, [Example 3] provides an image generation method, wherein the obtaining a target image material and a target text material based on the parsing of key information of the image material and the text material in the to-be-parsed material to form a target image-text material of the target object comprises:
performing image recognition and cutout processing on the image material in the to-be-parsed material to obtain at least one candidate cutout result;
screening the candidate cutout results according to set screening conditions, and taking the target cutout result obtained after screening as a target image material;
performing keyword extraction on the text material in the to-be-parsed material to obtain a target text material, and forming a target image-text material comprising the target image material and the target text material.

According to one or more embodiments of the present disclosure, [Example 4] provides an image generation method, which can further comprise:
optionally, the generating target image information based on the target image-text material and image generation configuration information of the target object comprises:
acquiring a predetermined element component set for construction of the target image, and acquiring image generation configuration information of the target object;
determining a target element component combination from the element component set and determining corresponding target component information according to the target image-text material in combination with historical target feedback information;
determining image layout information and image color matching information according to the target component information in combination with the image generation configuration information;
obtaining target image information, wherein the target image information comprises the target element component combination, target component information, image layout information and image color matching information.

According to one or more embodiments of the present disclosure, [Example 5] provides an image generation method, which comprises:
optionally, the determining a target element component combination from the element component set and determining corresponding target component information according to the target image-text material in combination with historical target feedback information comprises:
analyzing the target image-text material to determine corresponding target vertical category information and image-text feature information;
screening element components in the element component set according to the target vertical category information and image-text feature information to obtain at least one element component combination and corresponding component information;
determining a target element component combination from the element component combinations according to the historical target feedback information monitored after the launch of a historical target image, and taking the corresponding component information as the target component information.

According to one or more embodiments of the present disclosure, [Example 6] provides an image generation method, which comprises:
optionally, the determining image layout information and image color matching information according to the target component information in combination with the image generation configuration information comprises:
extracting element attribute information of target element components in a corresponding target element component combination from the target component information;
determining image layout information of the target element components in a to-be-generated image according to the element attribute information and the image generation configuration information;
updating color attribute information of element attribute information corresponding to the target element components as image color matching information of the target element components according to color information of the target image material in the target image-text material.

According to one or more embodiments of the present disclosure, [Example 7] provides an image generation method, which comprises:
optionally, the determining image layout information of the target element components in a to-be-generated image according to the element attribute information and the image generation configuration information comprises:
performing component classification on the target element components to obtain at least one type of element components;
determining processing priority of each type of element components, and analyzing the image generation configuration information to determine image generation constraint conditions;
determining the image layout information of the target element components in the to-be-generated image according to the processing priority in combination with the element attribute information and the image generation constraint conditions.

According to one or more embodiments of the present disclosure, [Example 8] provides an image generation method, which further comprises:
optionally, the updating color attribute information of element attribute information corresponding to the target element components as image color matching information of the target element components according to color information of the target image material in the target image-text material comprises:
clustering colors contained in the target image material in the target image-text material to determine a core color of the target image material;
projecting the core color into HSV color space to obtain angle information of the projected core color on a color wheel, and determining a target angle range based on the angle information;
adjusting color attributes of the target element components until the angle information obtained after projecting the color information corresponding to the target element components into the HSV color space is within the target angle range;
acquiring the adjusted color attribute information as the image color matching information of the target element components.

According to one or more embodiments of the present disclosure, [Example 9] provides an image generating apparatus, which comprises:
a material processing module for performing material parse processing on an original material of a target object to obtain a target image-text material of the target object;
an information generation module for generating target image information based on the target image-text material and image generation configuration information of the target object;
a poster generation module for generating and presenting a target poster type image of the target object based on the target image information.

The above-mentioned description is only the preferred embodiment of the present disclosure and the explanation of the applied technical principles. It should be understood by those skilled in the art that the disclosure scope involved in the present disclosure is not limited to the technical solution formed by the specific combination of the above-mentioned technical features, but also covers other technical solutions formed by any combination of the above-mentioned technical features or their equivalent features without departing from the above disclosure concept, for example, a technical solution formed by a replacement of the above-mentioned features with technical features with similar functions disclosed (but not limited to) in the present disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of a single separate embodiment can also be combined in a single embodiment. On the contrary, various features described in the context of a single embodiment can also be implemented in a plurality of embodiments individually or in any suitable sub-combination.

Although the present subject matter has been described in language specific to structural features and/or methodological logical actions, it should be understood that the subject matter defined in the appended Claims is not necessarily limited to the specific features or actions described above. On the contrary, the specific features and actions described above are only exemplary forms of implementing the Claims.

1. An image generation method, comprising:
performing material parse processing on an original material of a target object to obtain a target image-text material of the target object;
generating target image information based on the target image-text material and image generation configuration information of the target object;
generating a target image of the target object based on the target image information.

2. The method according to claim 1, wherein the performing material parse processing on the original material of the target object to obtain the target image-text material of the target object comprises:
receiving the original material of the target object, wherein the original material comprises a text material and at least one image material;
performing material screening on the text material and the image material to obtain a to-be-parsed material of the target object;
obtaining a target image material and a target text material based on the parsing of key information of the image material and the text material in the to-be-parsed material to form a target image-text material of the target object.

3. The method according to claim 2, wherein the obtaining the target image material and the target text material based on the parsing of key information of the image material and the text material in the to-be-parsed material to form the target image-text material of the target object comprises:
performing image recognition and cutout processing on the image material in the to-be-parsed material to obtain at least one candidate cutout result;
screening the candidate cutout results according to preset screening conditions, and taking the target cutout result obtained after screening as the target image material;
performing keyword extraction on the text material in the to-be-parsed material to obtain a target text material, and forming the target image-text material comprising the target image material and the target text material.

4. The method according to claim 1, wherein the generating target image information based on the target image-text material and image generation configuration information of the target object comprises:
acquiring a predetermined element component set for construction of the target image, and acquiring the image generation configuration information of the target object;
determining a target element component combination from the element component set and determining corresponding target component information according to the target image-text material in combination with historical target feedback information;
determining image layout information and image color matching information according to the target component information in combination with the image generation configuration information;
obtaining target image information, wherein the target image information comprises the target element component combination, the target component information, the image layout information, and the image color matching information.

5. The method according to claim 4, wherein the determining a target element component combination from the element component set and determining corresponding target component information, according to the target image-text material in combination with historical target feedback information comprises:
analyzing the target image-text material to determine corresponding target vertical category information and image-text feature information;
screening element components in the element component set according to the target vertical category information and image-text feature information to obtain at least one element component combination and corresponding component information;
determining a target element component combination from the element component combinations according to the historical target feedback information monitored after the launch of a historical target image, and taking the corresponding component information as the target component information.

6. The method according to claim 4, wherein the determining image layout information and image color matching information according to the target component information in combination with the image generation configuration information comprises:
extracting element attribute information of target element components in a corresponding target element component combination from the target component information;
determining image layout information of the target element components in a to-be-generated image according to the element attribute information and the image generation configuration information;
updating color attribute information in the element attribute information corresponding to the target element components as image color matching information of the target element components according to color information of the target image material in the target image-text material.

7. The method according to claim 6, wherein the determining the image layout information of the target element components in the to-be-generated image according to the element attribute information and the image generation configuration information comprises:
performing component classification on the target element components to obtain at least one type of element components;
determining processing priority of each type of element components, and analyzing the image generation configuration information to determine image generation constraint conditions;
determining the image layout information of the target element components in the to-be-generated image according to the processing priority in combination with the element attribute information and the image generation constraint conditions.

8. The method according to claim 6, wherein the updating color attribute information in the element attribute information corresponding to the target element components as image color matching information of the target element components according to the color information of the target image material in the target image-text material comprises:
clustering colors contained in the target image material in the target image-text material to determine a core color of the target image material;
projecting the core color into HSV color space to obtain angle information of the projected core color on a color wheel, and determining a target angle range based on the angle information;
adjusting color attributes of the target element components until the angle information obtained after projecting the color information corresponding to the target element components into the HSV color space is within the target angle range;
acquiring the adjusted color attribute information as the image color matching information of the target element components.

9. (canceled)

10. An electronic device, comprising:
one or more processors;
a storage means for storing one or more programs;
wherein the one or more programs, when executed by the one or more processors, cause the one or more processors to implement an image generation method, comprising:
performing material parse processing on an original material of a target object to obtain a target image-text material of the target object;
generating target image information based on the target image-text material and image generation configuration information of the target object;
generating a target image of the target object based on the target image information.

11. A non-transitory computer readable storage medium storing thereon a computer program, wherein the program, when executed by a processor, implements an image generation method, comprising:
performing material parse processing on an original material of a target object to obtain a target image-text material of the target object;
generating target image information based on the target image-text material and image generation configuration information of the target object;
generating a target image of the target object based on the target image information.

12. The electronic device according to claim 10, wherein the performing material parse processing on the original material of the target object to obtain the target image-text material of the target object comprises:
receiving the original material of the target object, wherein the original material comprises a text material and at least one image material;
performing material screening on the text material and the image material to obtain a to-be-parsed material of the target object;
obtaining a target image material and a target text material based on the parsing of key information of the image material and the text material in the to-be-parsed material to form a target image-text material of the target object.

13. The electronic device according to claim 12, wherein the obtaining the target image material and the target text material based on the parsing of key information of the image material and the text material in the to-be-parsed material to form the target image-text material of the target object comprises:
performing image recognition and cutout processing on the image material in the to-be-parsed material to obtain at least one candidate cutout result;
screening the candidate cutout results according to preset screening conditions, and taking the target cutout result obtained after screening as the target image material;
performing keyword extraction on the text material in the to-be-parsed material to obtain a target text material, and forming the target image-text material comprising the target image material and the target text material.

14. The electronic device according to claim 10, wherein the generating target image information based on the target image-text material and image generation configuration information of the target object comprises:
acquiring a predetermined element component set for construction of the target image, and acquiring the image generation configuration information of the target object;
determining a target element component combination from the element component set and determining corresponding target component information, according to the target image-text material in combination with historical target feedback information;
determining image layout information and image color matching information according to the target component information in combination with the image generation configuration information;
obtaining target image information, wherein the target image information comprises the target element component combination, the target component information, the image layout information, and the image color matching information.

15. The electronic device according to claim 14, wherein the determining a target element component combination from the element component set and determining corresponding target component information, according to the target image-text material in combination with historical target feedback information comprises:
analyzing the target image-text material to determine corresponding target vertical category information and image-text feature information;
screening element components in the element component set according to the target vertical category information and image-text feature information to obtain at least one element component combination and corresponding component information;
determining a target element component combination from the element component combinations according to the historical target feedback information monitored after the launch of a historical target image, and taking the corresponding component information as the target component information.

16. The electronic device according to claim 14, wherein the determining image layout information and image color matching information according to the target component information in combination with the image generation configuration information comprises:
extracting element attribute information of target element components in a corresponding target element component combination from the target component information;
determining image layout information of the target element components in a to-be-generated image according to the element attribute information and the image generation configuration information;
updating color attribute information in the element attribute information corresponding to the target element components as image color matching information of the target element components according to color information of the target image material in the target image-text material.

17. The non-transitory computer readable storage medium according to claim 11, wherein the performing material parse processing on the original material of the target object to obtain the target image-text material of the target object comprises:
receiving the original material of the target object, wherein the original material comprises a text material and at least one image material;
performing material screening on the text material and the image material to obtain a to-be-parsed material of the target object;
obtaining a target image material and a target text material based on the parsing of key information of the image material and the text material in the to-be-parsed material to form a target image-text material of the target object.

18. The non-transitory computer readable storage medium according to claim 17, wherein the obtaining the target image material and the target text material based on the parsing of key information of the image material and the text material in the to-be-parsed material to form the target image-text material of the target object comprises:
performing image recognition and cutout processing on the image material in the to-be-parsed material to obtain at least one candidate cutout result;
screening the candidate cutout results according to preset screening conditions, and taking the target cutout result obtained after screening as the target image material;
performing keyword extraction on the text material in the to-be-parsed material to obtain a target text material, and forming the target image-text material comprising the target image material and the target text material.

19. The non-transitory computer readable storage medium according to claim 11, wherein the generating target image information based on the target image-text material and image generation configuration information of the target object comprises:
acquiring a predetermined element component set for construction of the target image, and acquiring the image generation configuration information of the target object;
determining a target element component combination from the element component set and determining corresponding target component information, according to the target image-text material in combination with historical target feedback information;
determining image layout information and image color matching information according to the target component information in combination with the image generation configuration information;
obtaining target image information, wherein the target image information comprises the target element component combination, the target component information, the image layout information, and the image color matching information.

20. The non-transitory computer readable storage medium according to claim 19, wherein the determining a target element component combination from the element component set and determining corresponding target component information, according to the target image-text material in combination with historical target feedback information comprises:
analyzing the target image-text material to determine corresponding target vertical category information and image-text feature information;
screening element components in the element component set according to the target vertical category information and image-text feature information to obtain at least one element component combination and corresponding component information;
determining a target element component combination from the element component combinations according to the historical target feedback information monitored after the launch of a historical target image, and taking the corresponding component information as the target component information.

21. The non-transitory computer readable storage medium according to claim 19, wherein the determining image layout information and image color matching information according to the target component information in combination with the image generation configuration information comprises:
extracting element attribute information of target element components in a corresponding target element component combination from the target component information;
determining image layout information of the target element components in a to-be-generated image according to the element attribute information and the image generation configuration information;
updating color attribute information in the element attribute information corresponding to the target element components as image color matching information of the target element components according to color information of the target image material in the target image-text material.
